(19) United States
(12) Patent Application Publication
(10) Pub. No.: US 2026/0080277 A1
(43) Pub. Date: Mar. 19, 2026

(54) PROMPT BUILDER FLOW

(71) Applicant: Salesforce, Inc., San Francisco, CA (US)

(72) Inventors: Minhaj KHAN, New York, NY (US); Brady SAMMONS, Walnut Creek, CA (US); Avanthika RAMESH, San Francisco, CA (US); Karen YIN, San Jose, CA (US); Jan Adriaan KRUGER, Fuquay-Varina, NC (US)

(73) Assignee: Salesforce, Inc., San Francisco, CA (US)

(21) Appl. No.: 18/991,068

(22) Filed: Dec. 20, 2024

Related U.S. Application Data
(60) Provisional application No. 63/695,204, filed on Sep. 16, 2024.

(51) Int. Cl. G06N 5/04; G06N 3/02

(52) U.S. Cl. CPC G06N 5/04; G06N 3/02

(57) ABSTRACT

Disclosed herein are system, method, and computer program product embodiments for an improved prompt builder system. A system locates a data record based on matching a characteristic of the data record to a data record reference in a natural language prompt request. The system then masks a first field of the data record. For example, the first field may be altered or removed. The system then obtains a single-shot prompt response from a large language model (LLM) responsive to the natural language prompt request and the data record including the masked first field. The single-shot prompt response may include a second field from the data record.

### CROSS REFERENCE TO RELATED APPLICATIONS

This application claims the benefit of U.S. Provisional Application No. 63/695,204, filed Sep. 16, 2024, entitled Prompt Builder Flow, which is incorporated herein by reference in its entirety.

### BACKGROUND

One or more implementations relate to the field of improved prompt builder systems.

### BRIEF DESCRIPTION OF THE DRAWINGS

The accompanying drawings are incorporated herein and form a part of the specification.

FIG. 1A illustrates an exemplary environment for utilizing a prompt builder, according to aspects of the present disclosure.

FIG. 1B illustrates an exemplary environment for utilizing a prompt builder, according to aspects of the present disclosure.

FIG. 2 illustrates masking a data record, according to aspects of the present disclosure.

FIG. 3 illustrates a flowchart diagram of an exemplary method for generating using a prompt builder, according to aspects of the present disclosure.

FIG. 4 illustrates a flowchart diagram of an exemplary method for locating a data record, according to aspects of the present disclosure.

FIG. 5 illustrates a block diagram of an exemplary computer system for implementing one or more aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for a prompt builder system.

The proliferation of artificial intelligence (AI) has led to numerous advances in the ability of systems to analyze data and generate predictions. For example, many entities take advantage of machine learning models, such as large language models (LLM) to perform various tasks. LLMs are trained to perform various natural language tasks such as text summarization, sentiment analysis, language generation, machine translation, speech recognition, and question answering. LLMs are frequently interacted with via a prompt-response framework. A prompt may be a request including a task for an LLM to perform. For example, a prompt may be “What was the average temperature this past week in Washington, D.C.?” The LLM may input the prompt and predict a response. For example, the LLM may state “on average it was 90 degrees Fahrenheit.”

Although LLMs may demonstrate proficiency in various tasks, systems leveraging LLMs include various flaws. For example, LLMs may suffer from hallucinations. A hallucination may occur where an LLM fabricates data and treats the data as if it's true. This may be the result of various factors such as the LLM's design, training process, the prompt, or any combination thereof. For example, an LLM may be unable to access real-time data (e.g., current weather, latest news), unless it's provided within the prompt. As a result, unless the real-time data is provided in the prompt, there is a risk the LLM will fabricate data as part of its response.

Furthermore, LLMs may be hosted by third-party services that may update the LLM at any time. For example, the third-party may re-train (e.g., update) the LLM sporadically based on performance, usage, or any other factor. This introduces difficulty for users requiring consistent responses. For example, a user may request an LLM to draft a client-facing email. A month later, the user may submit the same request to the LLM, but the response may be different because the LLM was updated between the requests. The need for consistent responses is heightened in highly regulated industries such as finance and healthcare that may require certain disclosure to be present in all communications. Therefore, a user may be permitted to save a particular LLM response for future reference or use.

This architecture further introduces legal and privacy concerns. Various industries such as finance and healthcare are regulated by laws governing the types of data that may be shared, and the circumstances under which that data may be shared. However, when data is input to an LLM, especially one controlled by a third-party, any control over that data is lost. For example, the third-party may save the data, use it for training and testing purposes, share it with other parties, or a combination thereof. As a result, there is a need to be able to utilize third-party LLMs in a manner that complies with legal and privacy concerns.

Furthermore, LLMs are often interacted with in a chatbot interface where a user submits a partial request, the LLM responds, and the parties continue going back and forth until the user's end goal is reached. This paradigm increases the risk of data leakage occurring because information may be communicated between the user and the LLM multiple times.

Systems and methods described herein overcome at least the issues described above by utilizing a prompt builder system that allows data to be retrieved and included within prompts to LLMs, thus alleviating the risk of the LLM hallucinating and fabricating data. For example, as will be described below, the prompt builder system is configured to identify keywords within the prompt and retrieve data based on the keywords. The data may be any information such as from external sources (e.g., from the internet) or internal sources (e.g., from a business database). The retrieved data may be included within the prompt to the LLM, thus reducing the risk that the LLM will fabricate data. Furthermore, the systems and methods allow for data to be masked so that regulatory, legal, and privacy requirements may be complied with. Additionally, LLM responses may be saved for reuse. In some embodiments, the response may be modified prior to saving it. For example, user specific data included within the response may be removed. This may be beneficial in scenarios where the LLM is updated resulting in different responses, the LLM is hosted by a third party and taken offline, or a combination thereof.

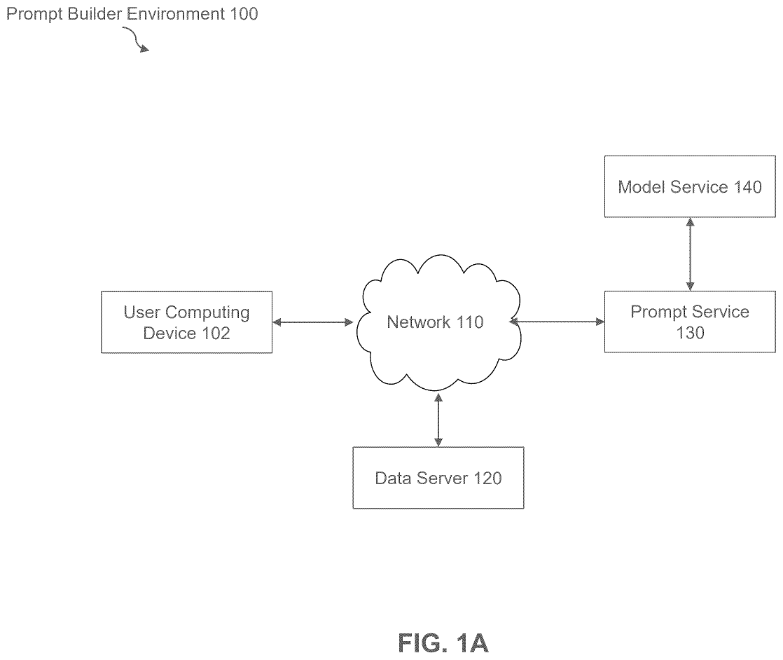

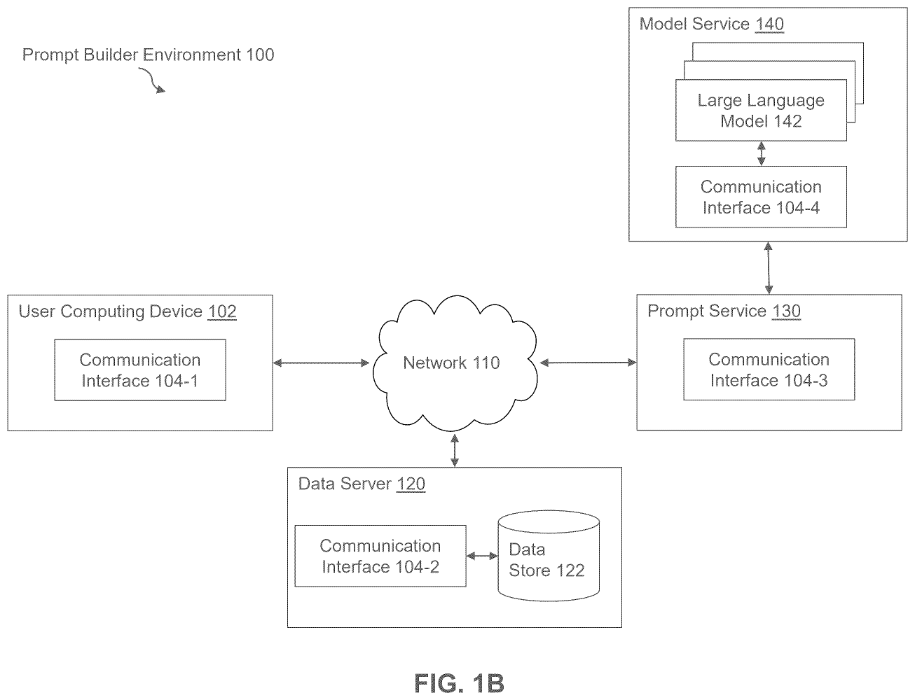

FIG. 1A illustrates prompt builder environment 100, according to embodiments of the present disclosure. Prompt builder environment 100 may include user computing device 102, network 110, data server 120, prompt service 130, and model service 140.

As will be discussed below, user computing device 102 may be configured to access data at data server 120 and interact with prompt service 130. For example, user computing device 102 may send a request to prompt service 130 for a task to be completed by a machine learning model. Prompt service 130 may receive a request from user computing device 102, and perform one or more processing steps. For example, prompt service 130 may obtain data from data server 120 identified in the request from user computing device 102. Prompt service 130 may be further configured to mask one or more data fields in data records retrieved from data server 120. Prompt service 130 may then send the request to model service 140. Model service 140 may include one or more machine learning models (e.g., LLMs). Model service 140 may route the request to one or more of the machine learning models, obtain a result, and forward the result to prompt service 130. Prompt service 130 may perform one or more post-processing steps. For example, prompt service 130 may undo masking previously performed on one or more data fields. Prompt service 130 may then forward the result to user computing device 102.

FIG. 1B illustrates prompt builder environment 100, according to embodiments of the present disclosure. Prompt builder environment 100 may include user computing device 102, network 110, data server 120, prompt service 130, and model service 140.

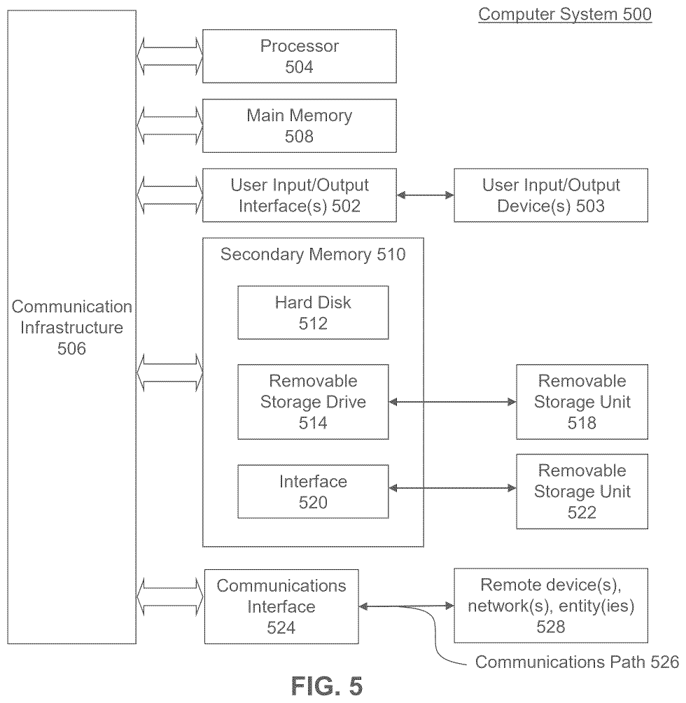

User computing device 102 may be any device configured to access and communicate with entities on network 110. User computing device 102 may be a computer system such as computer system 500 described with reference to FIG. 5. User computing device 102 may be a client system such as a desktop workstation, laptop or notebook computer, netbook, tablet, smart phone, and/or other computing device that may be using an enterprise computing system. Although a single user computing device 102 is depicted, prompt builder environment 100 may include any number of user computing devices 102.

User computing device may include communication interface 104-1. Communications interface 104 may be configured to communicate with entities on network 110. For example, communications interface 104-1 may allow mobile device 102 to communicate with data server 120 and prompt service 130, via network 110. Communications interface 104 may comprise any suitable network interface capable of transmitting and receiving data, such as, for example a modem, an Ethernet card, a communications port, or the like. Communications interface 104 may be able to transmit data using any wireless transmission standard such as, for example, Wi-Fi, Bluetooth, cellular, or any other suitable wireless transmission.

Network 110 may be any type of computer or telecommunications network capable of communicating data, for example, a local area network, a wide-area network (e.g., the Internet), or any combination thereof. The network may include wired and/or wireless segments. In some embodiments, network 110 may be a secure network. In some embodiments, user computing device 102 may reside within network 110. In some embodiments, user computing device 102 may reside outside network 110.

Data server 120 may be configured to access and manage data on network 110. Data service 120 may be implemented using one or more servers and/or databases. Although a single data server 120 is depicted in prompt builder environment 100, prompt builder environment 100 may include any number of data servers 120. For example, a first data server 120-1 may be associated with a financial institution (e.g., a bank) and a second data sever 120-1 may be associated with a healthcare institution (e.g., a hospital). Data server 120 may include communications interface 104-2 and data store 122. As discussed above, communications interface 104 may be configured to communicate with entities on network 110. Data store 122 may be any memory storage device configured to store data.

Data store 122 may be organized in any manner. For example, data store 122 may be a database of records, each record may include one or more fields. Data store 122 may store data associated with data server 120. For example, if data server 120 is associated with a financial institution, data store 122 may include bank account information. Each account may have a record with various fields such as an account type, an account owner, and a balance. As an additional example, if data server 120 is associated with a company, data store may include various records relating to products and employees.

Data server 120 may be configured to manage access to data store 122. Data server 120 may manage access by validating received credentials. In some embodiments, data server 120 may directly validate received credentials. In some embodiments, data server 120 may use a third-party entity to validate received credentials. Credentials may be any information used to verify the identity of a requesting identity. Credentials may be, for example, a username and password, biometric data, a challenge-response test, or a combination thereof. The credentials may be associated with an account. Data server 120 may be configured to assign and update permissions associated with an account. For example, an account may be able to read data, edit data, or a combination thereof. In some embodiments, data server 120 may require two-factor authentication to access data store 122. For example, data server 120 may send a code to an identifier (e.g., phone number or email address) associated with the account that the requesting entity is attempting to access.

For example, user computing device 102 may connect to data server 120. In some embodiments, user computing device 102 may attempt to access data at data store 122. Here, data server 120 may require user computing device 102 to perform an authentication process by submitting credentials. User computing device 102 may submit a username and password associated with an account at data server 120. In response, data server 120 may validate the username and password, and provide user computing device 102 access to data store 122. As stated above, based on the account accessed, user computing device 102 may be able to read and/or edit data at data store 122.

Prompt service 130 may be implemented using one or more servers and/or databases. Prompt service 130 may be a computer system such as computer system 500 described with reference to FIG. 5. Prompt service 130 may be a client system such as a desktop workstation, laptop or notebook computer, netbook, tablet, smart phone, and/or other computing device that may be using an enterprise computing system. Prompt service 130 may include communication interface 104-3. Prompt service 130 may be in communication with entities at network 110 such as user computing device 102, data server 120, and model service 140.

Prompt service 130 may be configured to receive prompt requests from devices such as user computing device 102. In some embodiments, prompt requests may be formulated as natural language (e.g., a natural language prompt request). For example, a prompt request may be “Generate a draft email to the CEO of ACME requesting a meeting next week.” User computing device 102 may submit a natural language prompt request to prompt service 130 through various mechanisms. For example, prompt service 130 may host an API accessible via network 110 allowing devices (e.g., user computing device 102) to submit natural language prompt requests. In some embodiments, prompt service 130 may host a webpage allowing a user associated with user computing device 102 to submit a natural language prompt request. In some embodiments, user computing device 102 may include credentials (e.g., username and password) within the request. In some embodiments, user computing device 102 may encrypt the request prior to sending it.

As will be discussed below, model service 140 may include any number of LLMs 142. In some embodiments, user computing device 102 may include with the natural langue prompt request, an indication of a specific LLM 142 to utilize. For example, user computing device 102 may specify an LLM 142 within an API call made to prompt service 130. Additionally, a user accessing a webpage hosted by prompt service 130 may select, at the user interface, a specific LLM 142 to use.

As will be discussed below, LLM 142 at model service 140 may be configured to input multi-modal data. For example, LLM 142 may be configured to input various data types such as text, video, audio, images, or any combination thereof. This may be beneficial so that user computing device 102 may include different data types within a natural language prompt request. Additionally, data at data server 120 may also be multi-modal. As a result, LLM 142 may be configured to input this data and generate a response.

Prompt service 130 may forward the request to one or more machine learning models at model service 140. Prompt service 130 may forward the response to user computing device 102.

Prompt service 130 may also be configured to retrieve data from data server 120. As discussed above, prior art systems may lack the ability to incorporate real data with an LLM. As a result, there is a risk that the LLM create (e.g., fabricate) the data, and treat it as if it's real. For example, a prior art system including an LLM may receive a prompt such as “Draft an email to the CEO of Acme reporting our projected Q3 profits.” However, the LLM may not have been trained on, or have access to data indicating who the ACME CEO is, or the projected Q3 profits. As a result, the LLM may insert false data that it was trained on, or create data and treat it as if it is true.

In contrast, prompt service 130 may access data from data server 120, include it with the prompt request, and send the request to model service 140. As a result, an LLM at model service 140 may reference the data and incorporate it within the response, thus preventing the LLM from referencing incorrect data or fabricating data.

Prompt service 130 may access data from data server 120 by detecting keywords within a prompt request. Prompt service 130 may include a list of key words or references identifying data at data server 120. For example, data server 120 may be associated with a company Acme, used to store employee data. Employee data may include information such as an employee's name, position, date of birth, salary, hire data.

Data server 120 may be configured to provide access to data at data server 120 via a keyword. For example, an employee's data may be accessed by querying data server with a request including “Employee.John.FIELD” where field corresponds to a data point corresponding to the employee John. For example, John's position may be retrieved by inputting “Employee.John.Position.” Here, the list of keywords associated with the prompt service 130 may include “Employee.”

When prompt service 130 detects a keyword or reference in the list corresponding to data at data server 120, prompt service 130 may extract the keyword from the prompt, and query data server 120 with the extracted keyword. For example, data server 120 may include an API allowing systems to submit and retrieve data. Data server 120 may return data from data store 122.

As discussed above, data server 120 may require the requester to validate its identity prior to being able to access data store 122. In some embodiments, prompt service 130 may request credentials (e.g., username and password) from user computing device 102 prior to accessing data server 120. Prompt service 130 may include the credentials in its request for data sent to data server 120. In some embodiments, prompt service 130 may send an identifier (e.g., email address, phone number) of user computing device 102 in the request to data server 120. In response, data server 120 may send a request for credentials to the identifier in the request from prompt service 130.

Data server 120 may return data from data store 122 to prompt service 130. For example, data server 120 may utilize an API at prompt service 130 to submit the data. In some embodiments, data server 120 may encrypt the data prior to sending the data to prompt service 130. In some embodiments, data server 120 may not return data. For example, the requested data may not exist. Additionally, user computing device 102 may not have access to the requested data. As a result, data server 120 may return a response indicating that the data cannot be located

Prompt service 130 may be further configured to mask data retrieved from data server 120. Masking may involve altering data that is submitted to model service 140. As discussed above, there may be regulatory, legal, and/or privacy concerns regarding passing data to a machine learning model. In order to mitigate these concerns, prompt service 130 may mask data from data server 120.

In some embodiments, masking may involve removing data retrieved from data server 120. For example, data server 120 may return a data record to prompt service 130. The data record may include a data field. For example, the data record maybe an employee profile and a data field may correspond to the employee's name. Prompt service 130 may be configured to remove data because including it within the prompt passed to model service 140 may violate a policy or law. Additionally, prompt service 130 may be configured to remove data based on a determination that a category of the data should not be used in interactions with model service 140. For example, prompt service 130 may detect profane language within a prompt and, in response, prompt service 130 may remove the profane language. Similar to the keyword detection regarding when to query data server 120, prompt service 130 may include a list of keywords to remove from a request prior to sending it to model service 140.

In some embodiments, masking may involve altering data. For example, prompt service 130 may change the data in the prompt from user computing device 102, data from data server 120, or both. Altering data may be necessary in a scenario where it may be useful for the LLM to reference the data type (e.g., a social security number) without using the real value.

For example, prompt service 130 may receive a request to summarize an employee's human resources file. In some embodiments, sharing certain data within the file may violate state and/or federal data privacy laws. However, the LLM may still need to be able to reference the data in order to generate an accurate summary. Here, to mask the data, prompt service 130 may alter one or more fields within the data record, such that the value is changed but the semantic meaning remains the same. For example, the HR file retrieved from data server 120 may include the employee's SSN. Prompt service 130 may be configured to not share data, such as SSNs, with model service 140. Here, prompt service 130 may alter the SSN. For example, prompt service 130 may replace the real SSN with a fake value using the same format. For example, the real SSN may be 123-456-7890 and prompt service 130 may replace the SSN with a value such as 111-222-3333. As a result, the LLM may utilize the fact that an SSN is included within the response, without the risk of sensitive data being shared. Similar to the keywords discussed above, prompt service 130 may include a list of words and/or data values to alter. Each word and/or data value may have a corresponding fake value to insert. For example, prompt service 130 may replace each detected SSN with 111-222-3333.

Once masked, prompt service 130 may create a data structure to input to model service 140. In some embodiments, the data structure may comply with a format specified by an API at model service 140. The data structure may include the natural language prompt request and a data record from data server 120. The data structure may also include an indication of a model at model service 140 to use. As will be discussed below, model service 140 may include multiple machine learning models such as LLM 142. User computing device 102 may specify a model at model service 140 to utilize. Here, prompt service 130 may include a field within the data structure indicating a model at model service 140 to utilize.

In some embodiments, user computing device 102 may not specify a model to utilize. Here, model service 140 may be configured to select a default LLM 142. Prompt service 130 may transmit the data structure to model service 140. In some embodiments, prompt service 130 may transmit the data structure to model service 140 via network 110.

Model service 140 may be implemented using one or more servers and/or databases. Model service 140 may be a computer system such as computer system 500 described with reference to FIG. 5. Model service 140 may be a client system such as a desktop workstation, laptop or notebook computer, netbook, tablet, smart phone, and/or other computing device that may be using an enterprise computing system. Although a single model service 140 is depicted, prompt builder environment 100 may include any number of model services 140. For example, each data server 120 may have a corresponding model service 140. Model service 140 may include communication interface 104-4 and large language model 142. Model service 140 may be in communication with prompt service 130. In some embodiments, LLM 142 may be hosted and maintained by a third-party.

LLM 142 may be a machine learning model used to perform various tasks. LLM 142 may be configured using any machine learning architecture. In some embodiments, LLM 142 may be built using a transformer architecture. LLM 142 may be trained to perform natural language processing tasks such as text summarization, sentiment analysis, language generation, machine translation, speech recognition, and questions answering. LLM 142 may be trained to receive a prompt and generate a response.

LLM 142 may be configured to input and output multi-modal data. For example, the prompt may include various data types such as text, video, audio, images, or any combination thereof. Similarly, LLM 142 may be configured to generate a multi-modal response including text, video, audio, images, or any combination thereof.

Model service 140 may include any number of LLMs 142. In some embodiments, each LLM 142 may be different. Each LLM 142 may be trained on different data sets. For example, a first LLM 142-1 may be trained on text data and a second LLM 142-1 may be trained on image and video data. Each LLM 142 may have gone through different training process. For example, a first LLM 142-1 may be trained using a first number of iterations over a set of training data and a second LLM 142-2 may be trained using a second number of iterations. Each LLM 142 may have been trained with different hyperparameters. For example, a first LLM 142-1 may be trained using a first batch size and a first learning rate, whereas a second LLM 142-2 may be trained with a second batch size and a second learning rate. Each LLM 142 may be built with different architectures. For example, a first LLM 142-1 may be constructed with a first number of layers, first number of parameters whereas a second LLM 142-2 may be constructed with a second number of layers and a second number of parameters.

Model service 140 may route the received data structure to LLM 142. In some embodiments, user computing device 102 may select LLM 142. As a result, prompt service 130 may include the identified LLM 142 within the data structure sent to model service 140. Additionally, user computing device 102 may include an indication to utilize multiple LLMs 142. Here, model service 140 may input the data structure including the natural language prompt request to each of the indicated LLMs 142. For example, model service 140 may copy the data structure and input it to each LLM 142.

LLM 142 may input the prompt request and generate a prompt. Model service 140 may send the generated prompt to prompt service 130. LLM 142 may leverage a field within the data record included within the prompt request. For example, LLM 142 may be trained to identify whether fields from the data record are relevant to the prompt request. For example, the request may state “generate an email to the CEO of Account.ACME.” Prompt service 130 may retrieve a record corresponding to Account.ACME from data store 122 at data server 120. Account.ACME may include a field corresponding to ACME's CEO. Here, the LLM 142 may identify that a field such as Account.ACME.CEO is included within the input, and as a result, include the value (e.g., John Smith) within the response.

In some embodiments, the single-shot prompt response generated by LLM 142 may include a data field altered by prompt service 130. For example, prompt service 130 may have altered a data field including an SSN. LLM 142 may input the prompt and data record, and identify that the SSN is relevant to the prompt. As a result, LLM 142 may include the altered SSN within the prompt response.

In some embodiments, LLM 142 may generate a single-shot prompt response. A single-shot prompt response may be a complete response to the natural language prompt request. As opposed to a chatbot system that may ask a user to iteratively provide information, here, prompt service 130 may send the user's entire request and LLM 142 may provide a complete response. This may be beneficial so that the single-shot prompt response may be reused in the future. For example, LLM 142 may be updated and as a result, return different or worse responses for the same natural language prompt request. Similarly, LLM 142 may be taken offline. Thus, it may be beneficial to have access to the response or a modified version of the response in the future.

Model service 140 may generate a data structure configured to store the output from LLM 142. The data structure may include an identifier or indication of the LLM 142 that generated the response. Model service 140 may write the response to the data structure in association with LLM 142 that generated the response. In some embodiments, model service 140 may copy the request/input data structure to track how LLM 142 responded to a specific input. This may be beneficial for training LLM 142 and for compliance tracking. For example, model service 140 may be required to record inputs from prompt service 130 and the outputs returned to prompt service 130 for compliance or legal purposes.

Model service 140 may return the response to prompt service 130. Prompt service 130 may store prompts generated by model service 140. As discussed above, this may be required for compliance with regulatory or legal requirements. Prompt service 130 may replace data that was previously masked. For example, prompt service 130 may have masked (e.g., altered) fields within data retrieved from data server 120 in order to prevent data leakage and/or to comply with regulatory or legal requirements. Here, prompt service 130 may undo the masking prior to returning data to user computing device 102.

For example, prompt service 130 may include a data structure to map fields it masked within the data structure sent to model service 140. For example, prompt service 130 may have replaced a real SSN with a fake SSN. As a result, prompt service 130 may replace the fake SSN with the real SSN prior to sending the response to user computing device 102. In some embodiments, prompt service 130 may not undo masking it performed. For example, prompt service 130 may not re-insert profane language previously removed.

Prompt service 130 may send the generated prompt to the requesting entity. For example, prompt service may send the prompt to user computing device 102. In some embodiments, the request may have included a request to send the generated prompt to a third party. For example, a first user computing device 102-1 may submit a natural language prompt request along and include an indication to send the prompt to a second user computing device 102-2. Here, prompt service 130 may send the generated prompt to the second user computing device 102-2.

In some embodiments, user computing device 102 may send a subsequent request responsive to the single-shot prompt response from model service 140. For example, a user associated with user computing device 102 may have included a mistaken within the natural language prompt request. For example, the natural language prompt request may have been a request for a draft email to the CEO of Acme Corp. but should have been addressed to the COO of Acme Corp. As an additional example, the single-shot prompt response may have included an error. Additionally, the user associated with user computing device 102 may be dissatisfied with the single-shot prompt response.

Here, user computing device 102 may be configured to send a second natural language prompt request. Model service 140 may generate a second single-shot prompt response from LLM 142 responsive to the second natural language prompt request. In some embodiments, the second single-shot prompt response may further be responsive to a data record referenced in the second natural language prompt request. Additionally, the second single-shot prompt response may be responsive to the previous single-shot prompt response. As will be discussed below, the previous response may be included within the subsequent request.

In some embodiments, user computing device 102 may use the same natural language prompt request previously sent, or modify the request. User computing device 102 may be configured to include the single-shot prompt response within the subsequent request. The subsequent request may further include references to the single-shot prompt response (e.g., the previously received response) that should be updated or removed. For example, user computing device 102 may have sent a natural language prompt request for a draft email to the CEO of Acme Corp., and model service 140 may have mistakenly returned a draft email to the COO. In response, user computing device 102 may send a subsequent prompt request including the draft email with the error. The subsequent prompt request may include a request to fix the error such as “Instead of the COO, address the email to the CEO of Acme Corp.” Model service 140 may save each interaction for future training.

In some embodiments, prompt service 130 may save single-shot responses from model service 130 for reuse. In some embodiments, the response may be saved in association with the natural language prompt request. Prompt service 130 may automatically save single-shot responses. In some embodiments, user computing device 102 may send a request to save a single-shot response. In some embodiments, the response may be modified prior to saving it. The modified response may be the single-shot response with data from data server 120 removed. For example, prompt service 130 may remove each data field it inserted from the data record retrieved from data server 120. Saving the modified single-shot responses may be beneficial so that they may be reused in the future.

As discussed above, LLM 142 may be maintained by a third party. The third party may control the architecture of LLM 142, how LLM 142 is trained, when LLM 142 is trained, etc. This creates the risk that LLM 142 may generate a first single-shot response to a prompt, be updated (e.g., re-trained), and generate a second single-shot response to the same prompt. This may be undesirable in scenarios where there is a need for the responses from LLM 142 to be consistent, such as in financial or healthcare industries. To address this issue, prompt service 130 may save the single-shot response and/or a modified version of the single-shot response. Thus, if LLM 142 is updated such that it generates a different response to a previously used prompt, or LLM 142 is taken offline, the response or a modified version of it may still be accessed.

For example, when prompt service 130 receives a request, it may search a storage device to determine whether a response or a modified version of the response already exists for the request. For example, a request may be to draft a sales pitch email to the CEO of Acme Corp. In response, prompt service 130 may search its storage device to determine whether a sales pitch email (e.g., the response) has already been generated. In some embodiments, prompt service 130 may include the previous response within the data structure sent to model service 140.

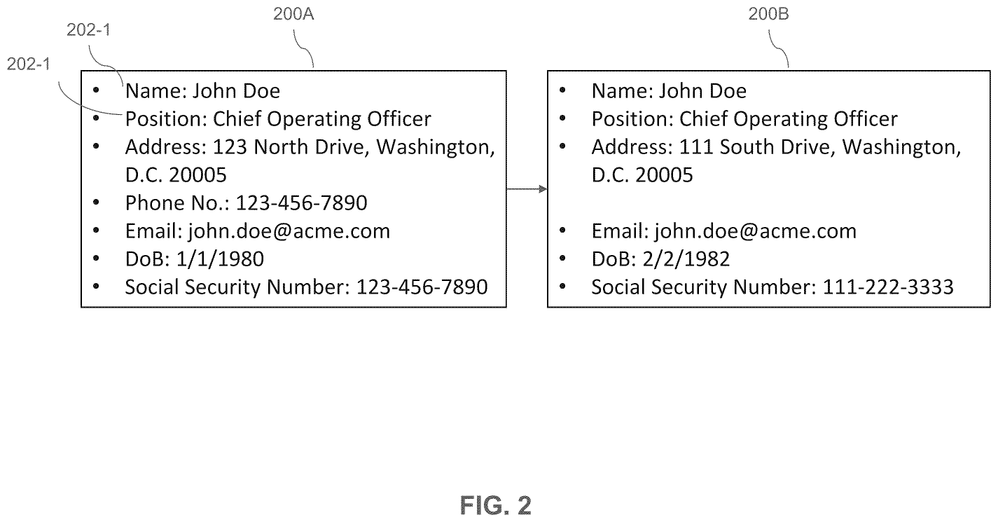

FIG. 2 illustrates masking a data record 200, according to aspects of the present disclosure. Data record 200 may be stored within data store 122 at data server 120. As discussed above, prompt service 130 may retrieve data record 200 from data server 120 in order to include one or more data fields 202 within the request sent to model service 140. As depicted, data record 200 may include any number of data fields 202. For example, a first data field 202-1 may correspond to an employee's name and a second data field 202-2 may correspond to the employee's position.

As discussed above, prompt service 130 may parse the retrieved data record (e.g., data record 200A) to identify any keywords within data record 200A. In some embodiments, data fields 202 identified by keywords may be removed, altered, and/or replaced. For example, prompt service 130 may include rule determining that phone numbers should be removed, prior to sending data to model service 140. As a result, prompt service 130 may generate modified data record 200B by removing the phone number data field 202. Additionally, prompt service 130 may include a keyword rule determining that certain data fields 202 should be altered. For example, data fields 202 corresponding to a social security number, date of birth, and address may be altered prior to sending them to model service 140. As discussed above, prompt service 130 may be configured to alter data fields 202 to preserve their semantic meaning. For example, an SSN may be altered to hide the true SSN, but the altered value may still appear as an SSN. For example, an SSN of 123-456-7890 may be altered to 111-222-3333. As a result, the machine learning models at model service 140 may generate predictions based off of the fact that an SSN is included within the request.

In some embodiments, prompt service 130 may maintain a data structure including alterations made to data record 200. This may be beneficial so that altered fields may be replaced prior to returning the response to user computing device 102. For example, prompt service 130 may include a data structure to map fields it masked within the data structure sent to model service 140. For example, prompt service 130 may have replaced a real SSN with a fake SSN. As a result, prompt service 130 may replace the fake SSN with the real SSN prior to sending the response back to user computing device 102. In some embodiments, prompt service 130 may not undo masking it performed. For example, prompt service 130 may not re-insert profane language removed from the data structure.

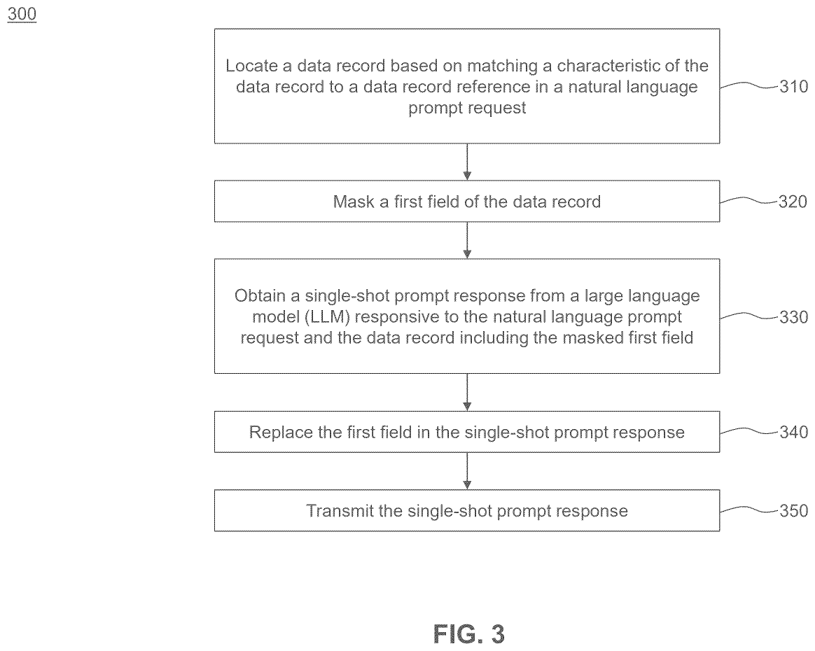

FIG. 3 illustrates a flowchart diagram of an exemplary method 300 for AI assistant integration on mobile according to embodiments of the present disclosure.

As shown in FIG. 3, the method begins at step 310 by prompt service 130 locating a data record based on matching a characteristic of the data record to a data record reference in a natural language prompt request. As discussed above, prompt service 130 may receive a natural language prompt request. The natural language prompt request may originate from user computing device 102. The natural language prompt request may be a request for a prompt from a machine learning model such as LLM 142. In some embodiments, the natural language prompt request may include a data record reference. The data record reference may be a keyword corresponding to data at data server 120. For example, the keyword may be “Account,” “Employee,” or “Patient.”

Prompt service 130 may include a list of keywords and locations where the data indicated by the keywords is stored within prompt builder environment 100. For example, the data may be stored within data store 122 at data server 120. Once prompt service 130 determines the location from the list of keywords, prompt service 130 may query the identified data server 120 for the data. For example, data server 120 may host an API and prompt service 130 may submit an API call to retrieve the data record. In some embodiments, data server 120 may authenticate the party requesting access to the data (e.g., user computing device 102) prior to providing access to the data. In some embodiments, prompt service 130 may forward credentials received from user computing device 102 to data server 120. In some embodiments, prompt service 130 may include an identifier (e.g., phone number or email address) corresponding to user computing device 102 within the request to data server 120. In response, data server 120 may contact user computing device 102 via the identifier to authenticate user computing device 102 and allow the request. Once authenticated, prompt service 130 may obtain the data record corresponding to the keyword.

At step 320, prompt service 130 masks a first field of the data record. As stated above, a data record (e.g., data record 200) may include any number of fields (e.g., data field 202). For example, a data record storing information for a bank account may include fields such as a name, account number, and account balance. Prompt service 130 may be configured to mask fields within a data record in order to comply with regulatory and/or legal requirements. Prompt service 130 may include a list of keywords corresponding to fields within the data records to mask. Masking may involve removing fields or altering fields. For example, prompt service 130 may be configured to remove a field listing a social security number. In some embodiments, prompt service may be configured to change a date of birth. In some embodiments, prompt service 130 may be configured to alter a field to produce a similar value. For example, a data field listing a salary may be altered within 10% of the original value. This may be beneficial to maintain the original meaning such that LLM 142 may reference it.

At step 330, prompt service 130 obtains a single-shot prompt response from a large language model (LLM). The LLM may be LLM 142 at model service 140. The single-shot prompt response may be responsive to the natural language prompt request, and the data record including the masked first field. In some embodiments, single-shot may be a complete response to the natural language prompt request. As opposed to a chatbot system that may ask a user to iteratively provide information, here, prompt service 130 may send the user's entire request and LLM 142 may provide a complete response. This may be beneficial to save a modified version of the response for future use. For example, an email drafted by LLM 142 responsive to a request may be saved for future use by removing data inserted from the data record. As stated above, LLM 142 may include one or more data fields from the data record within the response it generates. Once the data fields are removed, the modified version may be referenced in a scenario where LLM 142 returns different responses to the same prompt over time, or LLM 142 is inaccessible.

The single-shot prompt response may be formatted in various ways responsive to the natural language prompt request. For example, the single-shot prompt response may be formatted as natural language (e.g., English text) when indicated within the natural language prompt request. In some embodiments, the response may be formatted as a different language (e.g., Spanish). In some embodiments, the response may be formatted as source code, JSON, CSV, or XML. In some embodiments, the single-shot prompt response may include various types of data. For example, a first part of the response may be formatted as English text, a second part may be formatted as Python source code, and a third part may be formatted as JSON.

The single-shot prompt response may further be multi-modal. As discussed above, LLM 142 may be configured to input various types of data such as text, audio, images, and video. Here, LLM 142 may be further configured to include various types of data within the response. For example, LLM 142 may include both text and an image within the response.

At step 340, prompt service 130 replaces the first field in the single-shot prompt response. As discussed above, prompt service 130 may alter data fields within the data record in order to comply with company policies and/or regulatory schemes. In order to provide user computing device 102 an accurate response, prompt service 130 may be configured to undo the alterations it performed on data fields included within the response from LLM 142.

As discussed above, prompt service 130 may retrieve a data record referenced within the natural language prompt request from data server 120. Prompt service 130 may remove one or more fields, and/or alter one or more fields, prior to sending the request and the data record to model service 140. LLM 142 may reference and include the altered data fields when generating a response.

For example, user computing device 102 may submit a natural langue prompt request such as “Draft a sales pitch for product X to the CEO of Company.ACME.” Prompt service 130 may retrieve a data record listing various attributes of ACME such as ACME's chief officers, place of business, and quarterly profits. Prompt service 130 may reference a data structure such as a list of key: value pairings to determine whether to mask any data fields within the data record. As a result, prompt service 130 may alter one or more data fields such as profit information. Prompt service 130 may save a mapping of the data fields it altered. For example, prompt service 130 may save mapping corresponding to the data field, the data field original value, and the data field altered value. Prompt service 130 may generate a data structure by combining the natural language prompt request and the altered data record, and send the data structure to model service 140.

Model service 140 may return one or more single-shot prompt responses generated by one or more LLMs 142. Prompt service 130 may parse the response to identify whether it includes a data field that was altered. If an altered data field is detected, prompt service 130 may replace the altered data field value with the original data field value. For example, prompt service 130 may replace the altered profit information with the original profit information. As a result, prompt service 130 may only undo the alterations to data fields included within the single-shot prompt response because LLM 142 predicted those data fields were relevant to the request.

At step 350 prompt service 130 transmits the single-shot prompt response. Prompt service 130 may send the single-shot prompt response to the requesting entity, such as user computing device 102. In some embodiments, the natural language prompt response may include a request to send the single-shot prompt response to third parties. For example, the request may have indicated a list of identifiers (e.g., phone numbers or email addresses) to send the response to. As a result, prompt service 130 may be further configured to send the single-shot prompt response to the identified third parties via network 110.

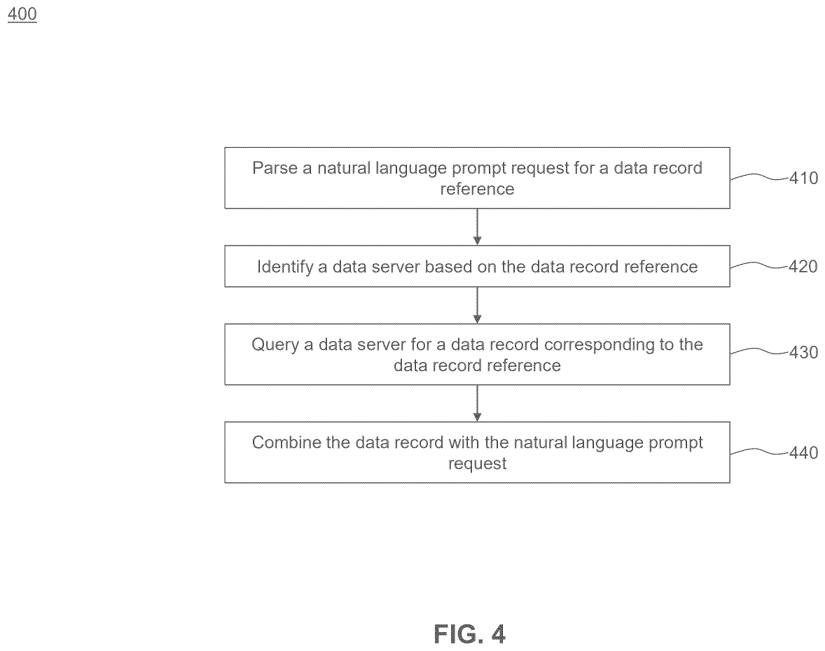

FIG. 4 illustrates a flowchart diagram of an exemplary method for locating a data record, according to aspects of the present disclosure.

As shown in FIG. 4, the method begins at step 410 by prompt service 130 parsing a natural language prompt request for a data record reference. A data record reference may be a keyword included within the natural language prompt request indicating that the keyword corresponds to data at data server 120. Prompt service 130 may include a list of keywords or references identifying data at data server 120.

At step 420, prompt service 130 identifies a data server based on the data record reference. Prompt service 130 may include a list of keywords or references for each data server 120 within prompt builder environment 100. This may be beneficial so that when a keyword based on a data record reference is detected, prompt service 130 may determine which data server 120 to query for the data record indicated by the reference.

In some embodiments, a data record referenced within the prompt request may map to multiple data servers 120. For example, a first data server 120-1 may be associated with a hospital and a second data server 120-2 may be associated with a bank. Each data server 120 may include data corresponding to a keyword such as “Employee.” Prompt service 130 may parse a request, and detect that the keyword “Employee” maps to the two data servers 120. In some embodiments, prompt service 130 may request data from each of the data servers 120 indicated by the keyword (e.g., both data server 120-1 and data server 120-2). In some embodiments, prompt service 130 may use an account or identity associated with the requester (e.g., user computing device 102) to make the determination.

As discussed above, in some embodiments, user computing device 102 may send credentials along with the request. User computing device 102 may further include a list of one or more data servers 120 it has access to. Here, prompt service 130 may reference the list provided by user computing device 102 to make the determination of which data server 120 to access. For example, if data server 120-2 is included in the access list but data server 120-1 is not, prompt service 130 may query data server 120-2. In some embodiments, prompt service 130 may query a third-party entity to determine which data servers 120 the account associated with user computing device 102 has access to.

At step 430, prompt service 130 queries a data server for a data record corresponding to the data record reference. The data server may be data server 120. Prompt service 130 may query the data server via network 110. For example, prompt service 130 may make a call to an API at data server 120. The API call may include the keyword in the natural language prompt request. Data server 120 may send the data record identified by the keyword to prompt service 130.

At step 440, prompt service 130 combines the data record with the natural language prompt request. In some embodiments, prompt service 130 may generate a data structure to combine the natural language prompt request and data record. For example, prompt service 130 may create a JSON object including the natural language prompt request and data record. As discussed above, prompt service 130 may remove or alter any sensitive data fields within the retrieved record. Prompt service 140 may send the data structure to model service 140.

Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include customer input/output device(s) 503, such as monitors, keyboards, pointing devices, etc., which may communicate with communication infrastructure 506 through customer input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random-access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings included in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method comprising:
locating, by one or more computing devices, a data record based on matching a characteristic of the data record to a data record reference in a natural language prompt request;
masking, by the one or more computing devices, a first field of the data record; and
obtaining, by the one or more computing devices, a single-shot prompt response from a large language model (LLM) responsive to the natural language prompt request and the data record including the masked first field,
wherein the single-shot prompt response includes a second field from the data record.

2. The computer implemented method of claim 1, further comprising:
obtaining, by the one or more computing devices, a second single-shot prompt response from the LLM responsive to the second natural language prompt request, the data record including the masked first field, and the single-shot prompt response.

3. The computer implemented method of claim 1, wherein masking the first field of the data record comprises at least one of:
removing, by one or more computing devices, the first field of the data record;
altering, by one or more computing devices, the first field of the data record; or
replacing, by one or more computing devices, the first field of the data record.

4. The computer implemented method of claim 1, further comprising:
receiving, by the one or more computing devices, identification of the LLM from a set of LLMs.

5. The computer implemented method of claim 1, further comprising:
removing, by the one or more computing devices, the second field from the single-shot prompt response; and
storing, by the one or more computing devices, the natural language prompt request and the single-shot prompt response.

6. The computer-implemented method of claim 1, wherein locating the data record further comprises:
identifying, by the one or more computing devices, an account associated with the natural language prompt request;
determining, by the one or more computing devices, a data server associated with the account; and
searching, by the one or more computing devices, the data server for the data record by matching the characteristic of the data record to the data record reference in a natural language prompt request.

7. The computer-implemented method of claim 1, wherein the single-shot prompt response is formatted as at least one of: natural language, JavaScript Object Notation (JSON), comma separated value (CSV), or Extensible Markup Language (XML).

8. A system, comprising:
a memory; and
at least one processor coupled to the memory and configured to:
locate a data record based on matching a characteristic of the data record to a data record reference in a natural language prompt request;
mask a first field of the data record; and
obtain a single-shot prompt response from a large language model (LLM) responsive to the natural language prompt request and the data record including the masked first field,
wherein the single-shot prompt response includes a second field from the data record.

9. The system of claim 8, wherein the at least one processor is further configured to:
obtain a second single-shot prompt response from the LLM responsive to the natural language prompt request, the data record including the masked first field, and the single-shot prompt response.

10. The system of claim 8, wherein to mask the first field of the data record, the at least one processor is further configured to:
removing, by one or more computing devices, the first field of the data record;
altering, by one or more computing devices, the first field of the data record; or replacing, by one or more computing devices, the first field of the data record.

11. The system of claim 8, wherein the at least one processor is further configured to:
receive identification of the LLM from a set of LLMs.

12. The system of claim 8, wherein the at least one processor is further configured to:
removing the second field from the single-shot prompt response; and
storing the natural language prompt request and the single-shot prompt response.

13. The system of claim 8, wherein to locate the data record the at least one processor is further configured to:
identify an account associated with the natural language prompt request;
determine a data server associated with the account; and
search the data server for the data record by matching the characteristic of the data record to the data record reference in a natural language prompt request.

14. The system of claim 8, wherein the single-shot prompt response is formatted as at least one of: natural language, JavaScript Object Notation (JSON), comma separated value (CSV), or Extensible Markup Language (XML).

15. A non-transitory computer-readable device having instructions stored thereon that, when executed by at least one computing device, cause the at least one computing device to perform operations comprising:
locating, by one or more computing devices, a data record based on matching a characteristic of the data record to a data record reference in a natural language prompt request;
masking, by the one or more computing devices, a first field of the data record; and
obtaining, by the one or more computing devices, a single-shot prompt response from a large language model (LLM) responsive to the natural language prompt request and the data record including the masked first field,
wherein the single-shot prompt response includes a second field from the data record.

16. The non-transitory computer-readable device of claim 15, the operations further comprising:
obtaining, by the one or more computing devices, a second single-shot prompt response from the LLM responsive to the natural language prompt request, the data record including the masked first field, and the single-shot prompt response.

17. The non-transitory computer-readable device of claim 15, wherein to mask the first field of the data record, the operations further comprise at least one of:
removing, by one or more computing devices, the first field of the data record;
altering, by one or more computing devices, the first field of the data record; or
replacing, by one or more computing devices, the first field of the data record.

18. The non-transitory computer-readable device of claim 15, the operations further comprising:
removing, by the one or more computing devices, the second field from the single-shot prompt response; and
storing, by the one or more computing devices, the natural language prompt request and the single-shot prompt response.

19. The non-transitory computer-readable device of claim 15, the operations further comprising:
identifying, by the one or more computing devices, an account associated with the natural language prompt request;
determining, by the one or more computing devices, a data server associated with the account; and
searching, by the one or more computing devices, the data server for the data record by matching the characteristic of the data record to the data record reference in a natural language prompt request.

20. The non-transitory computer-readable device of claim 15, wherein the single-shot prompt response is formatted as at least one of: natural language, JavaScript Object Notation (JSON), comma separated value (CSV), or Extensible Markup Language (XML).
